(19) United States
(12) Patent Application Publication
(10) Pub. No.: US 2014/0368347 A1
(43) Pub. Date: Dec. 18, 2014

(54) AUDIO AND LIGHTING ALERT APPARATUSES AND METHODS

(71) Applicant: James Allen White, Vernon, FL (US)

(72) Inventor: James Allen White, Vernon, FL (US)

(21) Appl. No.: 13/918,499

(22) Filed: Jun. 14, 2013

(51) Int. Cl. G08B 21/10

(52) U.S. Cl. CPC G08B 21/10
USPC 340/601

(57) ABSTRACT

An apparatus is described including a camera, a weather sensor, an alert button, a speaker, a light and a sign fixed to a support structure. Changed conditions can be acknowledged in one or more of the camera, the weather sensor and the alert button. Changed conditions can be broadcast from one or more of the speaker, the light and the sign. Additional embodiments are also described.

### BACKGROUND

People swim in ocean waters around the world. Ocean waters may present hazards to swimmers that are not readily apparent. Such hazards include, for example, rip tides, sharks or jellyfish. Many people die every year from unintentional drowning or injuries due to these hazardous conditions.

### BRIEF DESCRIPTION OF THE DRAWINGS

Some embodiments are illustrated by way of example and not limitation in the figures of the accompanying drawings in which:

FIG. 1 is a front view of an apparatus in the form of an audio and lighting alert system according to various embodiments of the invention;

FIG. 2 is a block diagram of an apparatus in the form of an audio and lighting alert system according to various embodiments of the invention;

FIG. 3 is a block diagram of an apparatus in the form of a control cabinet shown in FIG. 1 according to various embodiments of the invention; and

FIG. 4 is a flow diagram of a method according to various embodiments of the invention.

### DETAILED DESCRIPTION

For the purposes of this document, an “apparatus” can refer to any of a number of structures, such as circuitry, a device or a system.

Ocean waters may present hazards to swimmers such as, for example, rip tides, sharks or jellyfish. These challenges, as well as others, can be addressed by an audio and lighting alert system.

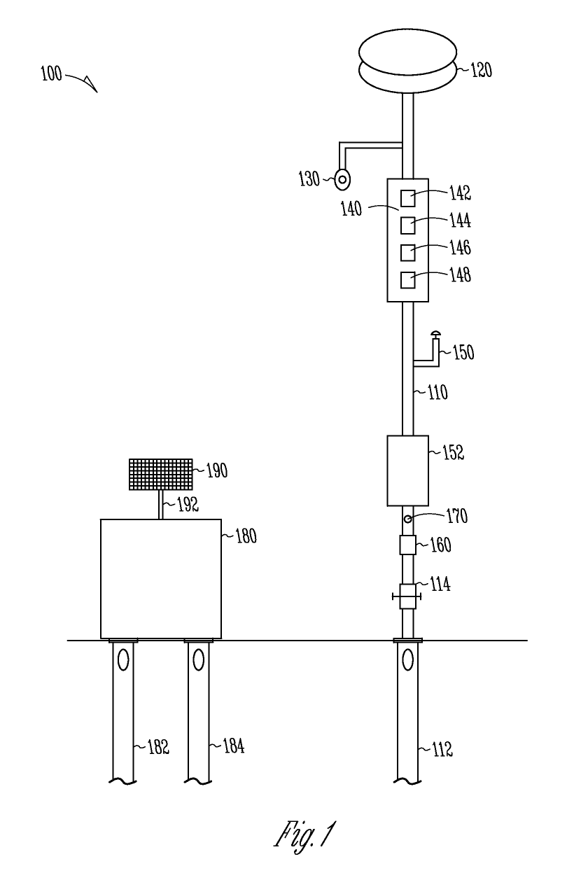

FIG. 1 is a front view of an apparatus in the form of an audio and lighting alert system 100 according to various embodiments of the invention. The audio and lighting alert system 100 is supported by an elongated support structure 110. The support structure 110 can be a hollow round aluminum pole approximately 30 feet long. The support structure 110 can comprise another structure such as, for example, an elongated beam with a rectangular or I-shaped cross-section or a tower with multiple legs and cross-beams. The support structure 110 can comprise another material such as steel or a material with carbon-fiber according to various embodiments of the invention. The support structure 110 can be anchored to sand or soil by a mounting pier 112. A hinge 114 can be included in the support structure 110 near the mounting pier 112 to permit the support structure 110 to be lowered from a vertical orientation for servicing and repair.

The audio and lighting alert system 100 can include a variety of components attached to the elongated support structure 110. A speaker 120 can be fixed to a top end of the support structure 110. The speaker 120 can be a loudspeaker or a siren. The speaker 120 can generate audible sound to warn of hazardous conditions. The speaker 120 can broadcast different tones such as a whoop or church bells. The speaker 120 can broadcast a verbal warning of hazardous conditions. The verbal warning can be broadcast from the speaker 120 in two or more languages.

A camera 130 can be fixed to the support structure 110 to collect visual data of weather conditions or human activity on a beach. The camera 130 can be used to monitor humans in hazardous conditions. The camera 130 can be a closed-circuit television (CCTV) camera. The visual data can be transmitted to an operator station by signals transmitted to an antenna (not shown) or transmitted over a wire (not shown). Control signals may be transmitted to the camera 130 through the antenna or over a wire (not shown) to control the camera 130.

A light assembly 140 can be fixed to the support structure 110 to emit visible light to warn of hazardous conditions. The light assembly 140 can generate light of multiple colors to communicate different messages depending on the color of the emitted light. The light assembly 140 may comprise multiple light-emitting diodes (LEDs) 142, 144, 146 and 148 that emit light at different wavelengths. For example, the LEDs 142, 144, 146 and 148 may emit light that is red, yellow, green and purple. The colors emitted by the light assembly 140 may be controlled by signals transmitted to an antenna (not shown) on the light assembly 140 or transmitted over a wire (not shown) connected to the light assembly 140. The light assembly 140 may include more or fewer than four LEDs according to various embodiments of the invention.

A weather sensor 150 can be fixed to the support structure 110 to collect data to indicate weather conditions. For example, the weather sensor 150 can collect data representing temperature, wind velocity, humidity and barometric pressure. Data collected by the weather sensor 150 can be transmitted to an operator station through a wire (not shown) or wirelessly through an antenna (not shown). The data can be analyzed to predict changes in the weather on a beach.

A sign 152 can be fixed to the support structure 110 to display information about hazardous conditions. The sign 152 can be a digital LED sign to display text of a warning of hazardous conditions or text indicating current weather conditions. An electrical access box 160 can be fixed to the support structure 110 to provide access to electrical wires (not shown).

An emergency alert button 170 can be fixed to the support structure 110 to permit a human to signal an emergency. Should the emergency alert button 170 be depressed a signal can be transmitted to an operator station through a wire (not shown) or wirelessly through an antenna (not shown) to indicate an emergency on the beach. The speaker 120 can generate audible sound and/or the light assembly 140 can emit visible light in response to the emergency alert button 170.

The speaker 120, the camera 130, the light assembly 140, the weather sensor 150, the sign 152, the electrical access box 160 and the emergency alert button 170 can be fixed to the support structure 110 by suitable mechanical devices such as bolts or clamps.

The audio and lighting alert system 100 includes a control cabinet 180 with electronics to control the audio and lighting alert system 100 according to various embodiments of the invention. The control cabinet 180 can be anchored to sand or soil by two or more mounting piers 182 and 184. A solar panel 190 can be attached to the control cabinet 180 by a solar panel support structure 192. The solar panel 190 may generate electrical current that can be coupled to a battery system (not shown) in the control cabinet 180 to charge the battery. The battery system may be used to provide power to the audio and lighting alert system 100 or to supplement power received through a wire (not shown). The control cabinet 180 can be coupled by wires (not shown) to communicate with an operator station and/or with the components on the support structure 110. The control cabinet 180 can include an antenna (not shown) to communicate wirelessly with an operator station and with the components on the support structure 110.

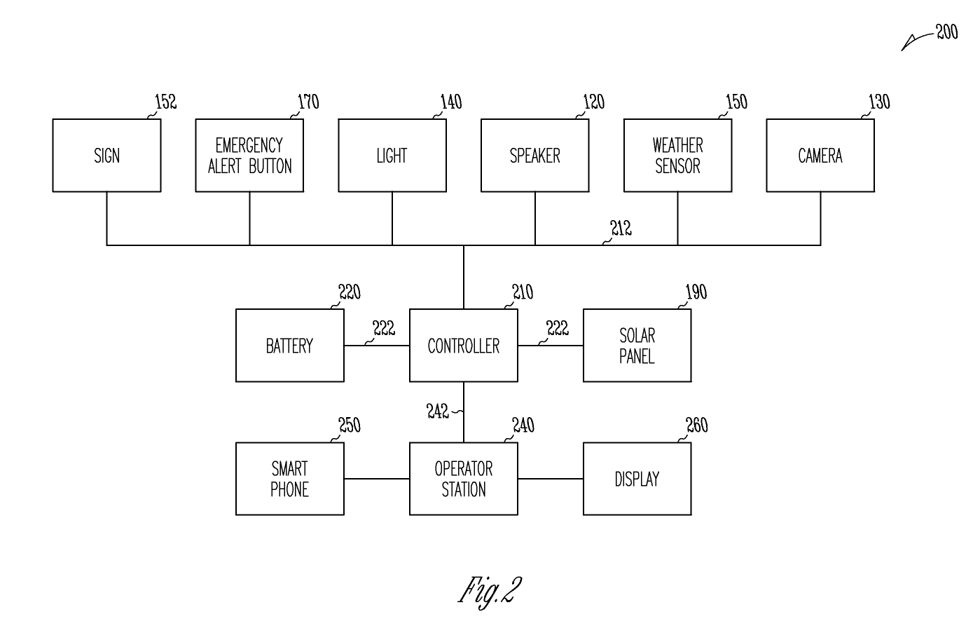

FIG. 2 is a block diagram of an apparatus in the form of an audio and lighting alert system 200 according to various embodiments of the invention. The audio and lighting alert system 200 includes components of the audio and lighting alert system 100 shown in FIG. 1, and these will not be further described for purposes of brevity. The audio and lighting alert system 200 can include the speaker 120, the camera 130, the light assembly 140, the weather sensor 150, the sign 152, and the emergency alert button 170 that are coupled to a controller 210 through wires that may comprise a bus 212. The speaker 120, the camera 130, the light assembly 140, the weather sensor 150, the sign 152, and the emergency alert button 170 may be coupled to the controller 210 wirelessly through antennas (not shown) according to various embodiments of the invention. Data from the camera 130, the weather sensor 150 and the alert button 170 may be received in the controller 210. The controller 210 may provide control signals to the speaker 120, the camera 130, the light assembly 140 and the sign 152.

The controller 210 may be located in the control cabinet 180 with a battery system 220. The solar panel 190 and the battery system 220 are coupled to the controller 210 through wires 222. The controller 210 may be a processor, a microprocessor, a state machine, a field-programmable gate array (FPGA) or an application-specific integrated circuit (ASIC).

The controller 210 may exchange information with an operator station 240 through a wired connection 242 or wirelessly through antennas (not shown). Humans in the operator station 240 can monitor conditions on a beach by observing the data produced by the audio and lighting alert system 100 and transmitted over the connection 242. The humans can control messages emitted and broadcast by the audio and lighting alert system 100 with control signals sent through the wired connection 242. The operator station 240 may include a smart phone 250 to speak to humans on the beach or through the speaker 120 and may include a display 260 to display video and data produced by the audio and lighting alert system 100.

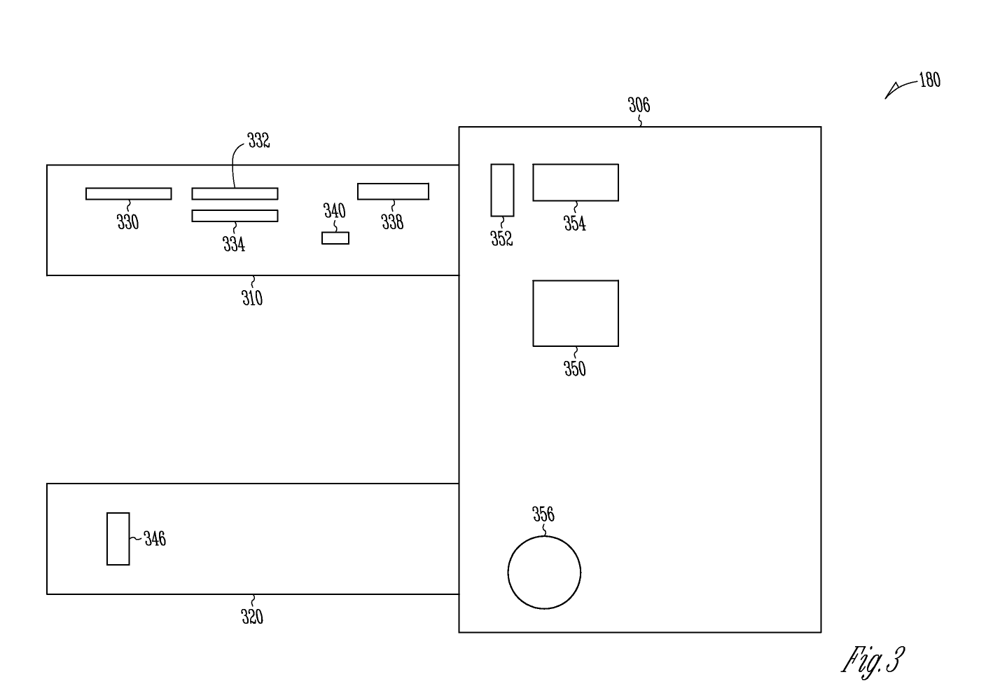

FIG. 3 is a block diagram of an apparatus in the form of the control cabinet 180 shown in FIG. 1 according to various embodiments of the invention. The control cabinet 180 includes a main body 306. A first panel 310 and a second panel 320 are attached to the main body 306. Circuit boards are attached to the first panel 310 including a digital voice board 330, a speaker control board 332, a radio/landline board 334 and an amplifier LED status board 338. A serial port 340 is also attached to the first panel 310. A solar charger card 346 is attached to the second panel 320. Attached to the main body 306 are a speaker amplifier 350, a strobe control board 352, a paging interface 354 and a battery switch 356 for a battery system (not shown) that may be used to connect or disconnect the battery system from the other components in the control cabinet 180.

The speaker amplifier 350 can receive audio tones and/or messages from the digital voice board 330 and amplify and deliver the tones and/or messages to the speaker 120. The strobe control board 352 can receive signals from the operator station 240 and deliver them to the light assembly 140. The paging interface 354 can receive signals from the operator station 240 and deliver them to the speaker 120 through the speaker amplifier 350. The battery switch 356 allows the battery system 220 to be disconnected from the controller 210. The digital voice board 330 can receive data from the operator station 240 and can control audio tones and messages broadcast by the speaker 120. The speaker control board 332 can control audio and voice messages from the digital voice board 330 and deliver them to the speaker amplifier 350. The radio/landline board 334 can control signals passing from the controller 210 to the operator station 240 via the wires 242 or wirelessly through antennas (not shown). The radio/landline board 334 can also control signals passing from the controller 210 to the battery system 220 or the solar panel 190 via the wires 222 or wirelessly through antennas (not shown). The amplifier LED status board 338 can display a diagnostic status of the speaker amplifier 350. The serial port 340 can provide serial communication as required. The solar charger card 346 can control electrical energy collected from the solar panel 190 and provided to the battery system 220.

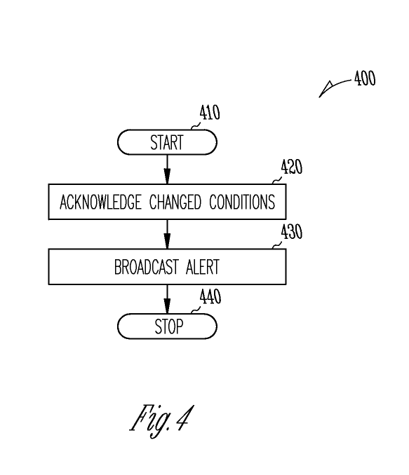

FIG. 4 is a flow diagram of a method 400 according to various embodiments of the invention. In block 410, the method 400 begins. In block 420, changed conditions such as weather conditions are acknowledged in one of several ways. The operator station 240 can acknowledge changed conditions. The changed conditions can also be detected by the camera 130, the weather sensor 150 or the emergency alert button 170 being depressed. In block 430, an alert is broadcast in one or more ways. For example, if the emergency alert button 170 is depressed, an alert is received in the operator station 240 and the light assembly 140 will display red, yellow and green colored lights. The lights may be flashing lights from the light assembly 140.

Conditions will indicate alerts that can be broadcast from the speaker 120 and the light assembly 140 in 430. Normal conditions can be indicated by displaying a green light from the light assembly 140 and broadcasting a single bell tone followed by a voice message “conditions good” from the speaker 120. A moderate hazard can be indicated by displaying a yellow light from the light assembly 140 and broadcasting a double bell tone followed by a voice message “use extreme caution, changing currents” from the speaker 120. Hazardous conditions can be indicated by displaying a red light from the light assembly 140 and broadcasting a triple bell tone followed by a voice message “dangerous rip currents, stay out of the water” from the speaker 120. A more severe hazard can be indicated by displaying a purple light from the light assembly 140 and broadcasting a high-low bell tone followed by a voice message “use extreme caution, marine hazards present” from the speaker 120.

Text messages of the alerts may be displayed by the sign 152. In block 440, the method 400 ends. Various embodiments may have more or fewer activities than those shown in FIG. 4. The activities shown may be accomplished in the illustrated order, or in another order. Some activities may be substituted for others.

Example apparatuses and methods of an audio and lighting alert system have been described. Although specific embodiments have been described, it will be evident that various modifications and changes may be made to these embodiments. Accordingly, the specification and drawings are to be regarded in an illustrative rather than a restrictive sense.

The Abstract of the Disclosure is provided to comply with 37 C.F.R. §1.72(b), requiring an abstract that allows the reader to quickly ascertain the nature of the technical disclosure. It is submitted with the understanding that it will not be used to interpret or limit the claims. In addition, in the foregoing Detailed Description, it may be seen that various features can be grouped together in a single embodiment for the purpose of streamlining the disclosure. This method of disclosure is not to be interpreted as limiting the claims. Thus, the following claims are hereby incorporated into the Detailed Description, with each claim standing on its own as a separate embodiment.

What is claimed is:

1. A method comprising:
acknowledging changed conditions in one or more of a camera, a weather sensor and an alert button fixed to a support structure; and
broadcasting a warning from one or more of a speaker, a light and a sign fixed to the support structure.

2. The method of claim 1, further comprising providing power to the support structure from a solar panel and a battery or from a wire.

3. The method of claim 1, further comprising:
receiving data from the camera, the weather sensor and the alert button in a controller; and
providing control signals to the speaker, the light, the camera, and the sign from the controller.

4. The method of claim 1, further comprising:
collecting data in the weather sensor representing weather conditions; and
transmitting the data representing weather conditions to an operator station.

5. The method of claim 1, further comprising:
collecting visual data in the camera of weather conditions; and
transmitting the visual data representing weather conditions to an operator station.

6. The method of claim 1, further comprising transmitting a signal from the alert button to an operator station.

7. The method of claim 1, further comprising transmitting the warning from an operator station to one or more of the speaker, the light and the sign.

8. A method comprising:
transmitting a warning to a support structure; and
broadcasting the warning from one or more of a speaker, a light and a sign fixed to the support structure.

9. The method of claim 8, wherein transmitting the warning further comprises transmitting the warning from a controller to the support structure.

10. The method of claim 8, wherein transmitting the warning further comprises transmitting the warning from an operator station to the support structure.

11. The method of claim 8, wherein broadcasting the warning further comprises displaying one of a green light, a yellow light, a red light and a purple light from the light.

12. The method of claim 8, wherein broadcasting the warning further comprises broadcasting a voice message from the speaker.

13. The method of claim 8, wherein broadcasting the warning further comprises broadcasting one or more tones from the speaker.

14. The method of claim 8, wherein broadcasting the warning further comprises displaying a text message on the sign.

15. An apparatus comprising:
a camera fixed to a support structure;
a weather sensor fixed to the support structure;
an alert button fixed to the support structure;
a speaker fixed to the support structure;
a light fixed to the support structure; and
a sign fixed to the support structure.

16. The apparatus of claim 15, wherein the support structure comprises a round pole.

17. The apparatus of claim 15, wherein:
the light comprises a plurality of light-emitting diodes (LED);
the sign comprises a digital LED sign.

18. The apparatus of claim 15, further comprising a solar panel and a battery coupled to the support structure.

19. The apparatus of claim 15, wherein the speaker comprises a siren or a loudspeaker.

20. The apparatus of claim 15, further comprising a controller coupled to the camera, the weather sensor, the alert button, the speaker, the light, the sign and an operator station to exchange data or signals.
